(19) United States
(12) Patent Application Publication
(10) Pub. No.: US 2006/0012935 A1
(43) Pub. Date: Jan. 19, 2006

(54) Transient protector circuit for multi-phase energized power supplies

(75) Inventor: Michael A. Murphy, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Elster Electricity, LLC

(21) Appl. No.: 10/890,085

(22) Filed: Jul. 13, 2004

(51) Int. Cl. H02H 3/22

(52) U.S. Cl. 361/111

(57) ABSTRACT

Circuits and systems are used in multi-phase power supplies for the prevention of transient currents. Phase to phase and phase to neutral metal oxide varistors (“MOV”) are replaced with a single DC power supply connected MOV. Transient currents are limited by resistors that are connected in series to each of the three phase inputs. Comprising a single DC connected MOV, protection from transients between any of the four inputs is provided. The phase to phase and the phase to neutral transient currents are routed, using diodes, through a single MOV connected between the positive and negative input terminals of the DC power supply.

### FIELD OF THE INVENTION

This invention relates in general to the field of high energy transient protection. More particularly, this invention relates to the design of circuitry for use in power supplies to protect against high energy transients.

### BACKGROUND OF THE INVENTION

The increasing usage of sensitive solid state devices in modem electrical systems, particularly computers, has given rise to concerns about transients. These concerns stem from the fact that the solid state devices are very susceptible to stray electrical transients which may be present in a distribution system. Transients in an electrical circuit result from the sudden release of previously stored energy. The severity of, and hence the damage caused by, transients depends on their frequency of occurrence, the peak transient currents, the voltages present, and their wave shapes.

It is common practice for power supplies to include circuitry that provides protection from high energy transients present at the input. This protection often comprises a metal oxide varistor (“MOV”) connected across the input conductors with an impedance, often a resistor, in series with one of the conductors to limit the current through the MOV.

The problem of providing transient protection is compounded for a supply energized from multiple phases. A traditional approach, shown in FIG. 1, comprises six MOVs: three between each phase and neutral, and three connected phase to phase. Current limiting resistors are connected in series with each phase. This circuit protects against transients between any of the four inputs.

More particularly, FIG. 1 illustrates a prior art circuit for the prevention of transients in a three phase power supply. There are four inputs into the circuit. The four inputs are A phase, B phase, C phase, and neutral, shown as inputs 101, 102, 103, and 104 respectively. While FIG. 1 is described with reference to a three phase power supply, those skilled in the art will appreciate that the circuit described is extendable for use in power supplies with more than three phases.

The circuit employs six MOVs to protect against high transient voltages between the phases. Three MOVs are disposed between each phase and neutral, and three MOVs are connected phase to phase. MOV 151 connects A phase with B phase, MOV 152 connects A phase with C phase, and MOV 153 connects A phase with neutral. MOV 154 connects B phase with C phase, MOV 155 connects B phase with neutral, and MOV 156 connects C phase with neutral. The MOVs are typically of a size sufficient to protect against the largest conceivable transient voltage between any of the phases and between any of the phases and neutral.

This circuit is able to protect against transients between any of the four inputs. This circuit effectively reduces high energy transients between any of the phases and any of the phases and neutral using six MOVs to a level benign to successive power supply components.

FIG. 2 illustrates a circuit diagram of an additional prior art circuit for the prevention of transients in a three phase power supply. There are four inputs into the circuit: A phase, B phase, C phase, and neutral, shown in FIG. 2 as inputs 201, 202, 203, and 204, respectively. While FIG. 2 is described with reference to a three phase power supply, those skilled in the art will appreciate that the circuit described is extendable for use in power supplies with more than three phases.

The circuit comprises four MOVs to protect against high energy transient voltages between the four inputs: one MOV between each phase and neutral, and one connected between the positive and negative terminals of the DC output. MOV 251 connects A phase with neutral, MOV 252 connects B phase with neutral, and MOV 253 connects C phase with neutral. MOV 254 connects, through diodes 261, 262, 263, 264, 271, 272, 273, and 274, each of the three phases.

Current limiting resistors are connected in series with each phase. Resistor 231 is connected in series with the A phase input, resistor 232 is connected in series with the B phase input, and resistor 233 is connected in series with the C phase input.

Diodes 261, 262, 263, 264, 271, 272, 273, and 274, along with MOV 254, create a circuit connecting each of the three phases together. This has the effect of routing transients between any of the three phases through the MOV 254, thus reducing them to a level benign to successive power supply components. The diodes are of the type suited to withstand the high currents that can pass through them as a result of the transients.

Diode pairs 261, 272 and 262, 271 provide a path for transients between inputs 201 and 202. Transients between inputs 201 and 202 are routed to MOV 254 through either the diode pair 261, 272 or 262, 271, depending on the polarity of the transient. MOV 254 lies on the circuit connection between diodes 261, 272 and 262, 271, and in conjunction with resistors 231 and 232, limits the transient voltage to a level benign to the remainder of the circuit.

Similarly, diode pairs 261, 273 and 263, 271 provide a path for transients between inputs 201 and 203. Transients between inputs 201 and 203 are routed to MOV 254 through either the diode pair 261, 273 or 263, 271 depending on the polarity of the transient. MOV 254 lies on the circuit connection between diodes 261, 273 and 263, 271, and in conjunction with resistors 231 and 233, limits the transient voltage to a level benign to the remainder of the circuit.

Furthermore, diodes 262, 273 and 272, 263 provide a path for transients between inputs 202 and 203. Transients between inputs 202 and 203 are routed to MOV 254 through either the diode pair 262, 273 or 272, 263 depending on the polarity of the transient. MOV 254 lies on the circuit connection between diodes 262, 273 and 272, 263, and in conjunction with resistors 232 and 233, reduces the transient voltage to a level benign to the remainder of the circuit.

However, these prior art circuits have significant drawbacks. For example, the cost of MOVs are high. MOVs are significantly more expensive than the other components making up the circuit. Moreover, MOVs of sufficient strength to reduce transients in a power supply are typically very large, especially when compared to the other components in the circuits, such as resistors and capacitors. Reducing the number of MOVs used in a given circuit can dramatically reduce the overall size of the circuit and minimize the requirement for costly circuit board area.

What is needed is a circuit that can protect against transients in a multi-phase power supply, while at the same time being significantly less expensive, less complex, and having fewer components than prior art circuits.

### SUMMARY OF THE INVENTION

The present invention is directed to circuits and systems for use in multi-phase power supplies for the control of transient currents. The present invention reduces transient currents to a level benign to succeeding power supply stages, while at the same time being less expensive and smaller than prior art circuits and systems such as those described in FIGS. 1 and 2.

According to aspects of the invention, phase to phase and phase to neutral MOVs are replaced with a single DC power supply connected MOV. Phase to phase transient currents are limited by resistors that are connected in series to each of the three phase inputs. Comprising a single DC connected MOV, an exemplary circuit provides protection from transients between any of the four inputs. The phase to phase and the phase to neutral transient currents are routed, desirably using diodes, through a single MOV connected between the positive and negative output terminals of the DC power supply. The single MOV is preferably the same size as the MOVs used in prior art circuits. Exemplary circuits and systems according to the present invention offer a net cost savings and can be implemented using significantly less circuit board area than prior methods.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 illustrates a prior art circuit diagram of a circuit for protection against transients in a three phase power supply;

FIG. 2 illustrates an additional prior art circuit for protection against transients in a three phase power supply;

FIG. 3 illustrates a circuit diagram of an exemplary circuit for protection against transients in a three phase power supply in accordance with the present invention;

FIG. 4 is a block diagram of components comprising an exemplary circuit in accordance with the present invention; and

FIG. 5 illustrates a flow diagram of an exemplary method of protection in accordance with the present invention.

### DETAILED DESCRIPTION OF ILLUSTRATIVE EMBODIMENTS

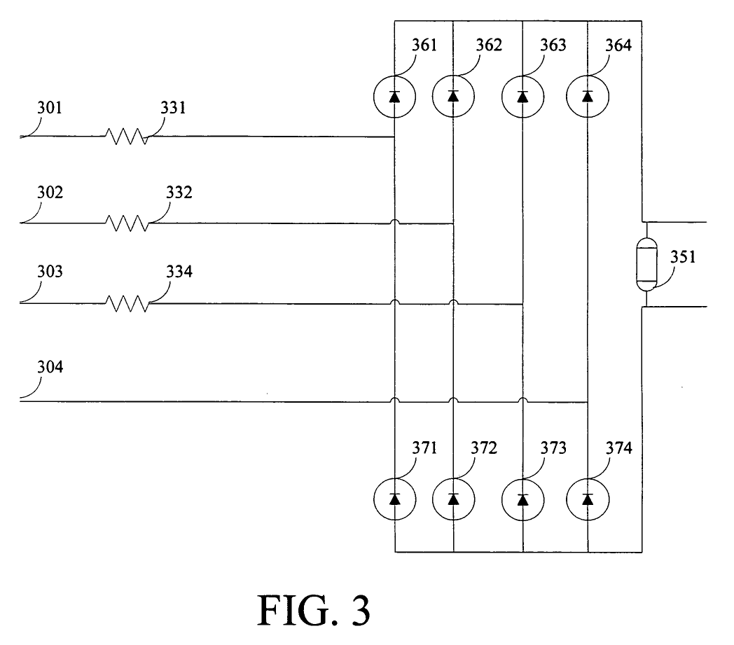

FIG. 3 illustrates a circuit diagram of an exemplary circuit for the prevention of transients in a three phase power supply in accordance with the present invention. The circuit utilizes only one MOV 351. This reduction in the number of MOVs results in a considerable saving of both money and circuit space. There are four inputs into the circuit: A phase, B phase, C phase, and neutral, shown in FIG. 3 as inputs 301, 302, 303, and 304, respectively. While FIG. 3 is described with reference to a three phase power supply, those skilled in the art will appreciate that the circuit described is extendable for use in power supplies with more than three phases.

The circuit employs one MOV 351 to protect against high energy transient voltages between the phases and between each of the phases and neutral. MOV 351 is connected between the terminals of the DC output. MOV 351 connects, through diodes 361, 362, 363, 364, 371, 372, 373, 374, each of the three phases and each of the three phases and neutral. A considerable cost savings is realized through the elimination of the additional MOVs shown in the prior art. In addition, space is saved on the circuit board allowing for smaller overall circuits.

Current limiting resistors are desirably connected in series with each phase. Resistor 331 is connected in series with A phase, resistor 332 is connected in series with B phase, and resistor 334 is connected in series with C phase. While not shown on FIG. 3, an impedance may also be connected in series with the neutral input, providing addition reduction in transient energy.

Suitable resistors generally have a power rating from 1 to 5 watts and resistances from 20 to 100 ohms. Bulk composition type resistors such as carbon composition or ceramic composition and specially constructed wire wound resistors are preferred.

Diodes 361, 362, 363, 364, 371, 372, 373, 374, along with MOV 351 comprise a circuit connecting each of the three phases with one another, and connecting each of the phases and neutral. This exemplary configuration routes transients through the MOV 351, thus reducing them to a level benign to successive components of the DC power supply. The diodes are preferably of the type suited to withstand the high energy transient voltages that can pass through them.

Suitable diodes will have a peak reverse voltage rating equal to or greater than the maximum voltage that can be developed across the MOV and non-repetitive peak forward surge current rating (“Ifsm”) of at least 40A. An exemplary diode having such characteristics is the General Semiconductor® DGP-15.

Diode pairs 361, 372 and 371, 362 provide a path for transients between inputs 301 and 302. Transients between inputs 301 and 302 are routed through MOV 351 by either the diode pair 361, 372, or 371, 362, depending on the polarity of the transient. MOV 351 lies on the circuit connection between diode pairs 361, 372, and 371, 362 and effectively reduces the transient to a level benign to subsequent DC power supply components.

Diode pairs 361, 373 and 371, 363 provide a path for transients between inputs 301 and 303. Transients between inputs 301 and 303 are routed through MOV 351 by either the diode pair 361, 373, or 371, 363, depending on the polarity of the transient. MOV 351 lies on the circuit connection between diode pairs 361, 373, and 371, 363 and effectively reduces the transient to a level benign to subsequent DC power supply components.

Diode pairs 361, 374 and 371, 364 provide a path for transients between inputs 301 and 304. Transients between inputs 301 and 304 are routed through MOV 351 by either the diode pair 361, 374, or 371, 364, depending on the polarity of the transient. MOV 351 lies on the circuit connection between diode pairs 361, 374, and 371, 364 and effectively reduces the transient to a level benign to subsequent DC power supply components.

Diode pairs 362, 373 and 372, 363 provide a path for transients between inputs 302 and 303. Transients between inputs 302 and 303 are routed through MOV 351 by either the diode pair 362, 373, or 372, 363, depending on the polarity of the transient. MOV 351 lies on the circuit connection between diode pairs 362, 373, and 372, 363 and effectively reduces the transient to a level benign to subsequent DC power supply components.

Diode pairs 362, 374 and 372, 364 provide a path for transients between inputs 302 and 304. Transients between inputs 302 and 304 are routed through MOV 351 by either the diode pair 362, 374, or 372, 364, depending on the polarity of the transient. MOV 351 lies on the circuit connection between diode pairs 362, 373, and 372, 363 and effectively reduces the transient to a level benign to subsequent DC power supply components.

Diode pairs 363, 374 and 373, 364 provide a path for transients between inputs 303 and 304. Transients between inputs 303 and 304 are routed through MOV 351 by either the diode pair 363, 374, or 373, 364, depending on the polarity of the transient. MOV 351 lies on the circuit connection between diode pairs 363, 374, and 373, 364 and effectively reduces the transient to a level benign to subsequent DC power supply components.

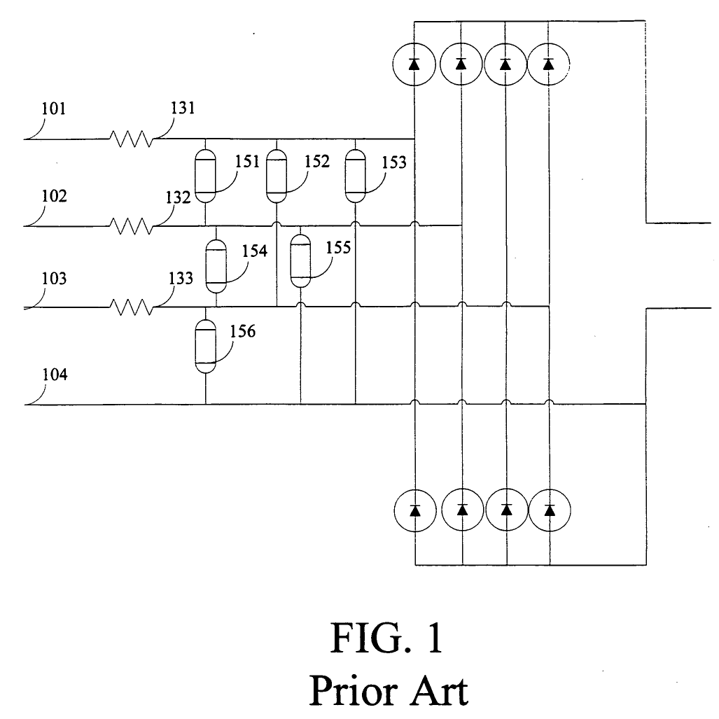

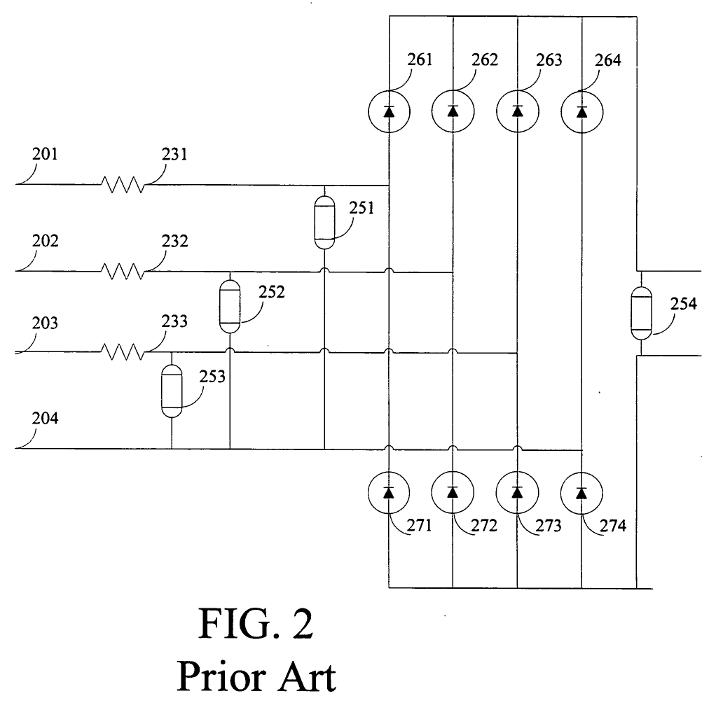

The MOV 351 utilized in the circuit of FIG. 3 is preferably of the same type as those MOVs in the prior art circuits (e.g., FIGS. 1 and 2). The exemplary circuit of a FIG. 3 replaces all of the MOVs of prior art FIGS. 1 and 2 with a single MOV 351. Thus, MOV 351 is preferably of a size sufficient to withstand multiple simultaneous transients between each the three phases. Suitable MOV's will typically have an energy rating in the 50 to 350 joule range and a clamping voltage rating of 900 to 1000 volts.

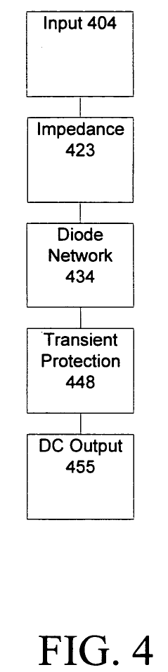

FIG. 4 is a block diagram of exemplary components comprising another exemplary circuit in accordance with the present invention. Such an exemplary circuit, which may be similar to that described with respect to FIG. 3, comprises several components including an input component 404, an impedance component 423, a diode network component 434, a transient protection component 448, and a DC output component 455.

The input component 404 receives the multi-phase electrical input, and desirably comprises inputs for the A phase, B phase, C phase, and a neutral input. Any method, technique, or system known in the art for receiving multi-phased input into a power supply can be used. While the exemplary embodiment is described with reference an A phase, a B phase, and a C phase, the present invention is applicable for use in power supplies with greater than three phases. An exemplary input component is illustrated in FIG. 3, for example, as phase inputs 301-303 and neutral input 304.

The impedance component 423 creates an impedance in series with each of the phase inputs to limit the size of transient voltages. An impedance may also be connected in series with the neutral input, providing additional reduction in transient energy. Any method, system, or technique known in the art for creating impedance in a circuit, such as a resistor may be used. An exemplary impedance component 423 is illustrated in FIG. 3, for example, as resistors 331-333.

The diode network component 434 directs transient currents between any of the three phase inputs and any of the three phase inputs and neutral. In addition, the diode network component is arranged to produce full wave rectification from the AC current to produce the DC output. The diode network component 434 can comprise eight diodes in total, for example, with two diodes connected in series between each of the phase inputs, and two diodes connected in series between each of the phase inputs and neutral. An exemplary diode network component 434 is illustrated in FIG. 3, for example, as diodes 361-364 and diodes 371-374.

The transient protection component 448 desirably reduces transient currents flowing between any of the three phase inputs and any of the three phase inputs and neutral, to a level benign to subsequent components of the DC power supply. The transient protection component 448 can comprise a single MOV connected in series, through the diode network 434, between each of the phase inputs, and each of the phase inputs and neutral, for example. Preferably, any transient in the circuit will be directed through the single MOV and reduced. An exemplary transient protection component 448 is illustrated in FIG. 3 as MOV 351, for example.

The DC output component 455 provides DC current to an attached device.

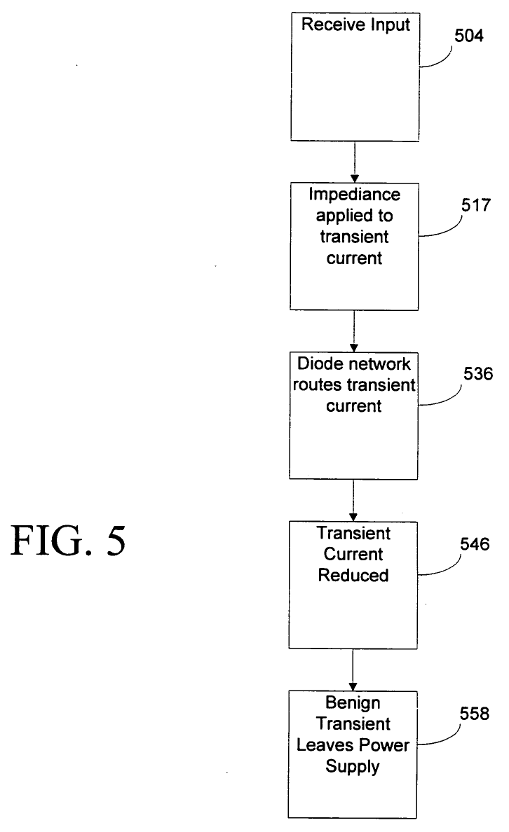

FIG. 5 illustrates a flow diagram of an exemplary method of protection in accordance with the present invention. An input current is received in a multi-phased power supply at 504, and may include transient voltages between any of the phases and any of the phases and neutral. An impedance connected in series with each of the phase inputs limits the transient current at 517. Transient currents between any of the phases and any of the phases and neutral pass through a diode network at 536. The transient currents pass through the MOV at 546, where the MOV effectively reduces the transient energy to benign levels suitable for the remaining power supply components. At 558, the benign transient leaves the circuit as output from the DC power supply.

More particularly, the input current is received at 504 and desirably comprises three phase inputs and a neutral input, as shown, for example, at inputs 301-304, in FIG. 3. A transient current can arise between any of the three inputs and any of the three inputs and neutral, and are desirably reduced at 517 through application of an impedance. The applied impedance may comprise current limiting resistors connected in series with each of the phase inputs, to reduce any transient currents that may have entered the circuit. An additional resistor may also be connected in series with the neutral input. An exemplary resistor set is shown in FIG. 3, at 331, 332, and 334.

At 536, the received current and any transient currents are routed through a diode network (e.g., the network shown in FIG. 3 and comprising diodes 361-364 and 371-374). The diodes are desirably connected in series with each of the phase input and neutral. This arrangement, necessary to produce full wave rectification from the AC inputs, forces any transient currents to travel through an MOV (e.g., MOV 351 in FIG. 3) connected between the terminals of the DC output, where, at 546, they are desirably reduced to an acceptable level. As a result, the power supply DC output, at 558, contains transients at a level that are benign to other circuits connected to the output.

It should be understood that the inventive principles described in this application are not limited to the components or configurations described in this application. It should be understood that the principles, concepts, systems, and methods shown in this application may be practiced with different equipment than is described in this application without departing from the principles of the invention.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed:

1. A system for protecting a direct current device connected to a multi-phase power supply comprising:
a plurality of phase inputs for receiving each of the phases of the power supply;
a neutral input;
a positive and a negative output for connecting to the direct current device;
a plurality of impedances;
only one metal oxide varistor, the metal oxide varistor connected in series between the positive and negative output; and
a plurality of diodes providing a connection between each phase input and each phase input and the neutral input, wherein the connection passes through the at least one metal oxide varistor connected in series between the positive and negative output.

2. The system of claim 1, wherein each impedance is connected in series with a corresponding one of the phase inputs.

3. The system of claim 1, wherein each impedance is connected in series with a corresponding one of the phase inputs and the neutral input.

4. The system of claim 1, wherein the metal oxide varistor is of a size sufficient to protect against the largest transient voltage between each of the phase inputs and each of the phase inputs and the neutral input.

5. The system of claim 1, wherein each of the diodes is of a size sufficient to handle the current caused by a transient voltage between any of the phase inputs and between any of the phase inputs and the neutral input.

6. A method of reducing transient currents in a system, comprising:
receiving a transient current from a multi-phase power supply at an input, wherein the input comprises a plurality of phase inputs and a neutral input;
applying an impedance to the transient current;
routing the transient current to a single metal oxide varistor; and
reducing the routed transient current at the metal oxide varistor to an acceptable level.

7. The method of claim 6, wherein applying the impedance to the transient current comprises routing the transient current through a resistor connected in series with a phase input.

8. The method of claim 6, wherein applying the impedance to the transient current comprises routing the transient current through a resistor connected in series with a phase input or the neutral input.

9. The method of claim 6, wherein routing the transient current comprises routing the transient current through a diode network, wherein a plurality of diodes are connected in series between each of the phase inputs and each of the phase inputs and the neutral input.

10. The method of claim 6, wherein the single metal oxide varistor is of a size sufficient to protect against the largest transient current between any of the phase inputs, and any of the phase inputs and the neutral input.

11. A circuit used to prevent transient currents, comprising:
an input component;
an impedance component connected to the input component;
a diode network component connected to the impedance component;
a transient protection component connected to the diode network component; and
a direct current output component connected to the transient protection component.

12. The circuit of claim 11, wherein the input component comprises:
a plurality of phase inputs; and
a neutral input.

13. The circuit of claim 12, wherein the impedance component comprises a plurality of resistors, wherein at least one resistor is connected in series with each of the plurality of phase inputs.

14. The circuit of claim 12, wherein the impedance component comprises a plurality of resistors, wherein at least one resistor is connected in series with each of the plurality of phase inputs and the neutral input.

15. The circuit of claim 12, wherein the transient protection component comprises only one metal oxide varistor connected in series between a positive and negative output of the direct current component.

16. The circuit of claim 15, wherein the metal oxide varistor is of a size sufficient to protect against the largest transient voltage between any two of the phase inputs, and each of the phase inputs and the neutral input.

17. The circuit of claim 15, wherein the diode network component comprises a plurality of diodes that provide a connection between each phase input and each phase input and the neutral input, wherein the connection passes through the metal oxide varistor connected in series between the positive and negative output.

18. The circuit of claim 17, wherein each of the diodes is of a size sufficient to handle the current caused by a transient voltage between any two of the phase inputs and each of the phase inputs and the neutral input.
